(19) United States
(12) Patent Application Publication
(10) Pub. No.: US 2016/0234807 A1
(43) Pub. Date: Aug. 11, 2016

(54) APPARATUS, SYSTEM AND METHOD OF RESCHEDULING BEACON TRANSMISSIONS

(71) Applicant: INTEL IP CORPORATION, Santa Clara, CA (US)

(72) Inventors: Matan LEVY, Zur Moshe (IL); Tomer DANIEL, Herzliya (IL); Jonathan SEGEV, Tel Mond (IL)

(73) Assignee: Intel IP Corporation

(21) Appl. No.: 15/026,609

(22) PCT Filed: Dec. 19, 2013
(86) PCT No.: PCT/US2013/076602

§ 371 Date: Apr. 1, 2016

(51) Int. Cl. H04W 72/00; H04W 72/12; H04L 12/26; H04W 40/24

(52) U.S. Cl. CPC H04W 72/005; H04W 40/244; H04W 72/12; H04L 43/12

(57) ABSTRACT

Some demonstrative embodiments include apparatuses, systems and/or methods of rescheduling beacon transmissions. For example, an apparatus may include a wireless communication unit to reschedule broadcasting of a plurality of beacons from a first beacon schedule to a second beacon schedule, comprising means for first beacon schedule including a first sequence of beacon transmission times separated by a predefined beacon interval period, and comprising means for second beacon schedule including a second sequence of beacon transmission times separated by the predefined beacon interval period, the second sequence of beacon transmission times being shifted from the first beacon transmission times by a delay period, and wherein the wireless communication unit is to transmit at least one information element including timing information of the second beacon schedule.

### TECHNICAL FILED

Some demonstrative embodiments relate to rescheduling beacon transmissions.

### BACKGROUND

In some wireless communication networks, communication may be performed during beacon intervals (BI), which may be scheduled, for example, according to a beacon and/or an announce frame.

A network controller, for example, an Access Point (AP), a Group Owner (GO) or a Personal-basis-service-set Control Point (PCP), may repetitively broadcast beacon frames periodically, for example during a sequence of Target Beacon Transmission times (TBTTs), which may be separated by a predefined beacon interval.

In congested environments, e.g., including a large number of APs, an AP may have to defer transmission of a beacon frame over a wireless communication medium, for example, if the wireless communication medium is not free during the TBTT.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative embodiments.

FIG. 2 is a schematic illustration of four relative timing states of first and second beacons schedules, in accordance with some demonstrative embodiments.

FIG. 3 is a schematic illustration of first and second beacon schedules, in accordance with some demonstrative embodiments.

FIG. 4 is a schematic flow-chart illustration of a method of scheduling beacon transmissions, in accordance with some demonstrative embodiments.

FIG. 5 is a schematic illustration of a product of manufacture, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some embodiments may be used in conjunction with various devices and systems, for example, a Personal Computer (PC), a desktop computer, a mobile computer, a laptop computer, a notebook computer, a tablet computer, an Ultrabook™ computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with devices and/or networks operating in accordance with existing Wireless-Gigabit-Alliance (WGA) specifications (Wireless Gigabit Alliance, Inc WiGig MAC and PHY Specification Version 1.1, April 2011, Final specification) and/or future versions and/or derivatives thereof, devices and/or networks operating in accordance with existing IEEE 802.11 standards (IEEE 802.11-2012, IEEE Standard for Information technology—Telecommunications and information exchange between systems Local and metropolitan area networks—Specific requirements Part 11: Wireless LAN Medium Access Control (MAC) and Physical Layer (PHY) Specifications, Mar. 29, 2012; IEEE802.11 task group ac (TGac) (“IEEE802.11-09/0308r12—TGac Channel Model Addendum Document”); IEEE 802.11 task group ad (TGad) (IEEE P802.11ad-2012, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 3: Enhancements for Very High Throughput in the 60 GHz Band, 28 December, 2012)) and/or future versions and/or derivatives thereof, devices and/or networks operating in accordance with existing and/or Wireless Fidelity (WiFi) Alliance (WFA) Peer-to-Peer (P2P) specifications (WiFi P2P technical specification, version 1.2, 2012) and/or future versions and/or derivatives thereof, devices and/or networks operating in accordance with existing WirelessHD™ specifications and/or future versions and/or derivatives thereof, units and/or devices which are part of the above networks, and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems and/or networks.

The phrase “wireless device”, as used herein, includes, for example, a device capable of wireless communication, a communication device capable of wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the term “wireless device” may optionally include a wireless service.

The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

Some demonstrative embodiments may be used in conjunction with suitable limited-range or short-range wireless communication networks, for example, a wireless area network, a “piconet”, a WPAN, a WVAN and the like. Other embodiments may be used in conjunction with any other suitable wireless communication network.

Some demonstrative embodiments may be used in conjunction with a wireless communication network communicating over a frequency band of 60 GHz. However, other embodiments may be implemented utilizing any other suitable wireless communication frequency bands, for example, an Extremely High Frequency (EHF) band (the millimeter wave (mmwave) frequency band), e.g., a frequency band within the frequency band of between 30 GHz and 300 GHZ, a WLAN frequency band, a WPAN frequency band, a frequency band according to the WGA specification, and the like.

The term “antenna”, as used herein, may include any suitable configuration, structure and/or arrangement of one or more antenna elements, components, units, assemblies and/or arrays. In some embodiments, the antenna may implement transmit and receive functionalities using separate transmit and receive antenna elements. In some embodiments, the antenna may implement transmit and receive functionalities using common and/or integrated transmit/receive elements. The antenna may include, for example, a phased array antenna, a single element antenna, a set of switched beam antennas, and/or the like.

The term “station” (STA), as used herein, may include any logical entity that is a singly addressable instance of a medium access control (MAC) and a physical layer (PHY) interface to a wireless medium (WM).

The phrase “access point” (AP), as used herein, may include an entity that contains one station (STA) and provides access to distribution services, via the WM for associated STAs.

The phrase “non-access-point (non-AP) station (STA)”, as used herein, may relate to a STA that is not contained within an AP.

The phrases “directional multi-gigabit (DMG)” and “directional band” (DBand), as used herein, may relate to a frequency band wherein the Channel starting frequency is above 40 GHz.

The phrases “DMG STA” and “mmWave STA (mSTA)” may relate to a STA having a radio transmitter, which is operating on a channel that is within the DMG band.

The phrase “personal basic service set” (PBSS), as used herein, may relate to a basic service set (BSS) that forms a self-contained network. For example, the PBSS may operate in the DMG band, and may include one PBSS control point (PCP).

The phrase “PBSS control point” (PCP), as used herein, may include an entity that contains one station (STA) and coordinates access to the WM by STAs that are members of a PBSS.

The phrase “non-PCP station (STA)”, as used herein, may relate to a STA that is not also a PCP.

The phrase “non-PCP/non-AP station (STA)”, as used herein, may relate to a STA that is not a PCP and that is not an AP.

The phrase “PCP/AP”, as used herein, may relate to a STA that is a PCP or an AP.

The phrase “peer to peer (PTP or P2P) communication”, as used herein, may relate to device-to-device communication over a wireless link (“peer-to-peer link”) between a pair of devices. The P2P communication may include, for example, wireless communication over a direct link within a QoS basic service set (BSS), a tunneled direct-link setup (TDLS) link, a STA-to-STA communication in an independent basic service set (IBSS), or the like.

The phrase “Peer-to-peer” (P2P) network, as used herein, may relate to a network in which a STA in the network can operate as a client or as a server for another STA in the network. The P2P network may allow shared access to resources, e.g., without a need for a central server.

The phrase “P2P device”, as used herein, may relate to a WFA P2P device that may be capable of acting as both a P2P Group Owner and a P2P Client.

The phrase “P2P Client”, as used herein, may relate to a P2P device that may be connected to a P2P Group Owner.

The phrase “P2P Group owner”, as used herein, may relate to an “AP-like” entity, when referring to non-DMG networks, or to a PCP, when referring to DMG networks that may provide and use connectivity between clients.

The phrase “P2P Group”, as used herein, may relate to a set of devices including one P2P Group Owner and zero or more P2P Clients.

The phrase “Beacon interval”, as used herein, may relate to a number of time units (TUs) between beacon transmission times, e.g., target beacon transmission times (TBTTs).

The phrase “beacon transmission interval” (BTI), as used herein, may relate to a time interval between the start of a first beacon transmission by a STA in a beacon interval to an end of a last beacon transmission by the STA in the same beacon interval.

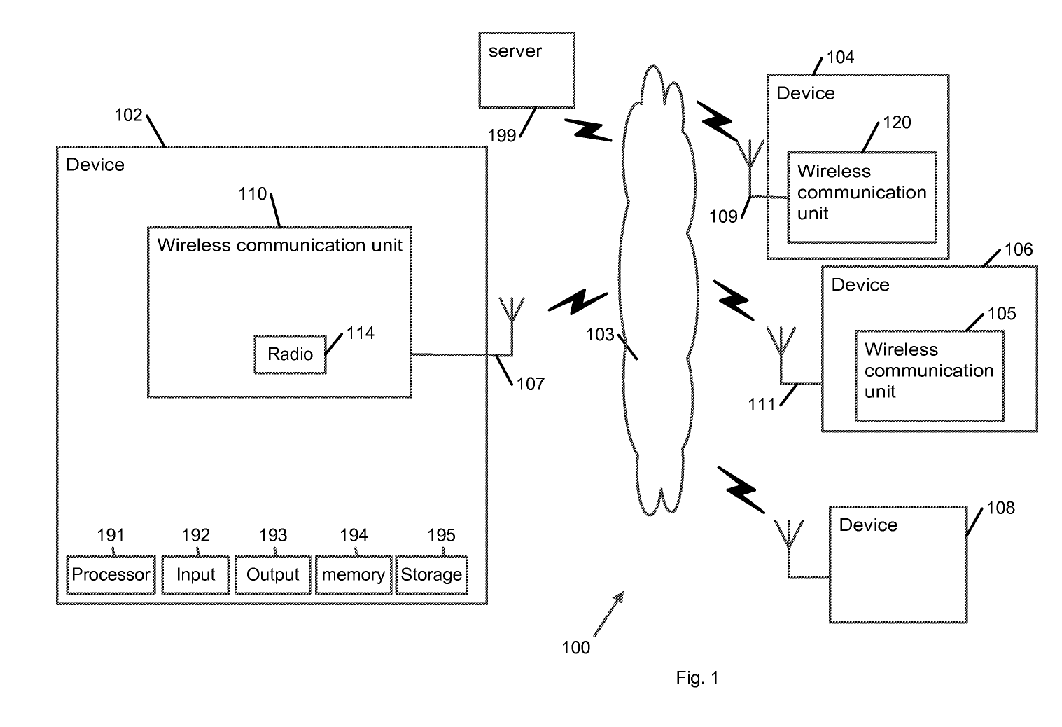

Reference is now made to FIG. 1, which schematically illustrates a block diagram of a system 100, in accordance with some demonstrative embodiments.

As shown in FIG. 1, in some demonstrative embodiments system 100 may include a wireless communication network including one or more wireless communication devices, e.g., wireless communication devices 102, 104, 106 and/or 108, capable of communicating content, data, information and/or signals over a wireless communication medium 103, for example, a radio channel, an IR channel, a RF channel, a Wireless Fidelity (WiFi) channel, and the like. One or more elements of system 100 may optionally be capable of communicating over any suitable wired communication links.

In some demonstrative embodiments, wireless communication devices 102, 104 106 and/or 108 may include, for example, a PC, a desktop computer, a mobile computer, a laptop computer, an Ultrabook™ computer, a notebook computer, a tablet computer, a server computer, a handheld computer, a handheld device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player, or the like.

In some demonstrative embodiments, wireless communication devices 102, 104, 106 and/or 108 may include wireless communication units, to perform wireless communication between wireless communication devices 102, 104, 106 and/or 108 and with one or more other wireless communication devices. For example, device 102 may include a wireless communication unit 110, device 104 may include a wireless communication unit 120 and/or device 106 may include a wireless communication unit 105, e.g., as described below.

Wireless communication devices 102, 104, 106 and/or 108 may also include, for example, one or more of a processor 191, an input unit 192, an output unit 193, a memory unit 194, and a storage unit 195. Wireless communication devices 102, 104, 106 and/or 108 may optionally include other suitable hardware components and/or software components. In some demonstrative embodiments, some or all of the components of one or more of wireless communication devices 102, 104, 106 and/or 108 may be enclosed in a common housing or packaging, and may be interconnected or operably associated using one or more wired or wireless links. In other embodiments, components of one or more of wireless communication devices 102, 104, 106 and/or 108 may be distributed among multiple or separate devices.

Processor 191 includes, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 executes instructions, for example, of an Operating System (OS) of wireless communication devices 102, 104, 106 and/or 108 and/or of one or more suitable applications.

Input unit 192 includes, for example, a keyboard, a keypad, a mouse, a touch-screen, a touch-pad, a track-ball, a stylus, a microphone, or other suitable pointing device or input device. Output unit 193 includes, for example, a monitor, a screen, a touch-screen, a flat panel display, a Cathode Ray Tube (CRT) display unit, a Liquid Crystal Display (LCD) display unit, a plasma display unit, one or more audio speakers or earphones, or other suitable output devices.

Memory unit 194 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 includes, for example, a hard disk drive, a floppy disk drive, a Compact Disk (CD) drive, a CD-ROM drive, a DVD drive, or other suitable removable or non-removable storage units. Memory unit 194 and/or storage unit 195, for example, may store data processed by wireless communication devices 102, 104, 106 and/or 108.

In some demonstrative embodiments, wireless communication units 110, 120 and 105 may include, or may be associated with, one or more antennas 107, 109 and 111, respectively. Antennas 107, 109 and 111 may include any type of antennas suitable for transmitting and/or receiving wireless communication signals, blocks, frames, transmission streams, packets, messages and/or data. For example, antennas 107, 109 and 111 may include any suitable configuration, structure and/or arrangement of one or more antenna elements, components, units, assemblies and/or arrays. Antennas 107, 107 and 111 may include, for example, antennas suitable for directional communication, e.g., using beamforming techniques. For example, antennas 107, 109 and 111 may include a phased array antenna, a single element antenna, a set of switched beam antennas, and/or the like. In some embodiments, antennas 107, 109 and 111 may implement transmit and receive functionalities using separate transmit and receive antenna elements. In some embodiments, antennas 107, 109 and 111 may implement transmit and receive functionalities using common and/or integrated transmit/receive elements.

In some demonstrative embodiments, wireless communication units 110, 120 and/or 105 include, for example, one or more radios 114, e.g., including one or more wireless transmitters, receivers and/or transceivers able to send and/or receive wireless communication signals, RF signals, frames, blocks, transmission streams, packets, messages, data items, and/or data. For example, wireless communication units 110, 120 and/or 105 may include or may be implemented as part of a wireless Network Interface Card (NIC), and the like.

In some demonstrative embodiments, one or more devices of system 100 may perform the functionality of a network controller. For example, device 102 may perform the functionality of a first network controller, e.g., a first AP, and device 104 may perform the functionality of a second network controller, e.g., a second AP.

In some demonstrative embodiments, wireless communication devices 102, 104, 106 and/or 108 may perform the functionality of DMG STAs, e.g., wireless communication devices 102, 104, 106 and/or 108 may be configured to communicate over the DMG band.

In some demonstrative embodiments, system 100 may include at least one PCP/AP STA and one or more non-PCP/non-AP STAs. For example, devices 102 and 104 may perform the functionality of a PCP/AP STA and/or devices 106 and/or 108 may perform the functionality of a non-PCP/AP STA.

In some demonstrative embodiments, wireless communication devices 102, 104 106 and/or 108 may perform the functionality of WFA P2P devices. For example, devices 102 and/or 104 may perform the functionality of a P2P group owner, and devices 106 and/or 108 may perform the functionality of a P2P client device.

In some demonstrative embodiments, devices 102, 104, 106 and/or 108 may communicate during one or more beacon intervals (BI).

In some demonstrative embodiments, a network controller, e.g., device 102 or device 104, may be configured to transmit beacon frames according to a beacon schedule including a sequence of beacon transmission times separated by a predefined beacon interval period.

For example, device 102 may perform the functionality of a first AP to transmit beacon frames according to a beacon schedule including a first sequence of TBTTs separated by a predefined BI period. Device 104 may perform, for example, the functionality of a second AP to transmit beacon frames according to a beacon schedule including a second sequence of TBTTs separated by a predefined BI period. Devices 106 and/or 108 may perform, for example, the functionality of non-PCP/AP STAs to receive the beacon frames from devices 102 and/or device 104.

Some demonstrative embodiments are described herein with reference to a beacon schedule including a sequence of TBTTs. However, other embodiments may be implemented with respect a beacon schedule including a sequence of any other beacon transmission times to broadcast beacons.

In some demonstrative embodiments, both devices 102 and 104 may utilize a common predefined BI period. For example, each pair of consecutive TBTTs of the first sequence of TBTTs and each pair of consecutive TBTTs of the second sequence of TBTTs may be separated by the common predefined BI period. In other embodiments, different BI periods may be used.

In some demonstrative embodiments, device 102 may attempt to transmit a beacon frame during a TBTT of the first sequence of TBTTs, for example, after determining that wireless communication medium 103 is free for transmission. Device 102 may defer the transmission of the beacon frame, for example, upon determining that wireless communication medium 103 is not free for transmission and/or upon determining that a potential collision will occur between the beacon frame and another transmission being performed over wireless communication medium 103.

In some demonstrative embodiments, the first sequence of TBTTs utilized by device 102 may at least partially overlap with the second sequence of TBTTs utilized by AP 104.

As a result, device 102 may not be able to transmit the beacon frame during the TBTT, for example, when the TBTT of the first sequence of TBTTs overlaps a TBTT of the second sequence of TBTTs utilized by device 104.

Accordingly, device 102 may defer transmission of the beacon frame, e.g., until device 104 completes the transmission of the beacon frame and/or until a subsequent TBTT.

As the number of APs in system 100 increases, the probability of overlap between TBTTs and, consequently, the delay in transmitting the beacon frame from device 102 may increase. The delay in transmitting the beacon frame from device 102 may result, for example, in increased latency and/or jitter of traffic communicated in the network controlled by device 102. Additionally, the delay in transmitting the beacon frame may result in an increase in a duration a station, e.g., device 106, may be required to remain awake to receive the beacon frame, e.g., during a power save mode of the station. As a result, power consumption of the station may increase.

In some demonstrative embodiments, devices 102 and 104 may schedule the first TBTT sequence to be shifted with respect to the second TBTT sequence, e.g., in an attempt to avoid overlapping between the first and second TBTT sequences.

In some demonstrative embodiments, devices 102 and 104 may use a local clock to determine the timing of the TBTTs. As the local clocks of devices 102 and 104 may drift, a relative timing between the local clocks of devices 102 and 104 may deviate. As a result, the first and second TBTT sequences may collide and/or at least partially overlap, e.g., as described below.

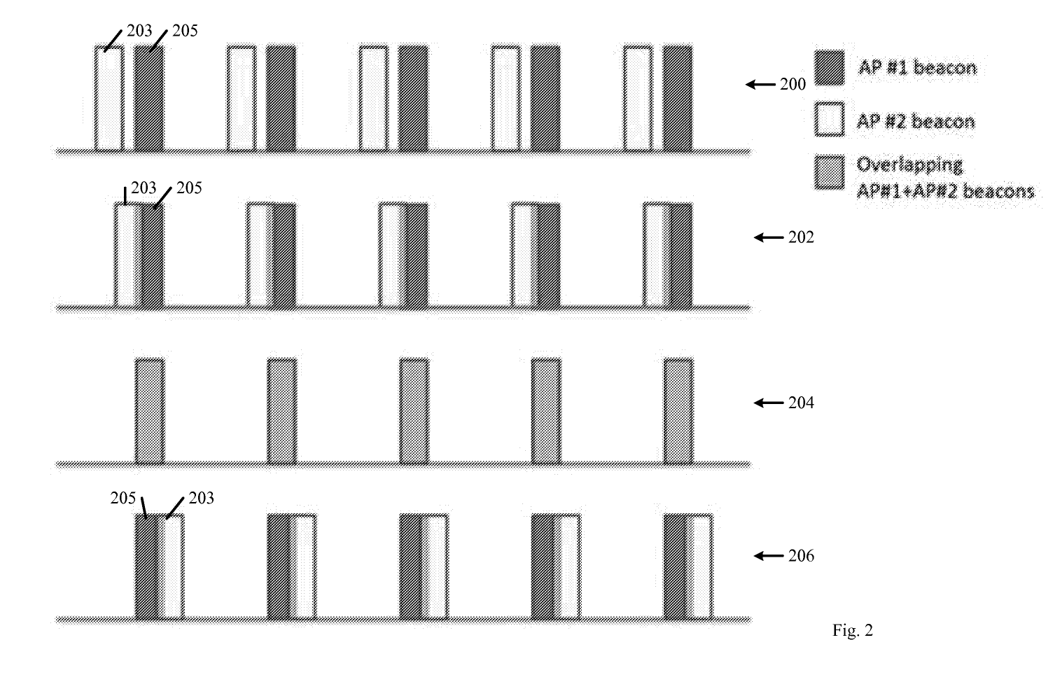

Reference is made to FIG. 2, which schematically illustrates a first relative timing state 200 of first and second beacons schedules, a second relative timing state 202 of the first and second beacons schedules, a third relative timing state 204 of the first and second beacons schedules, and a fourth relative timing state 200 of the first and second beacons schedules, in accordance with some demonstrative embodiments. For example, a first AP, e.g., device 102 (FIG. 1), may schedule beacon transmissions according to the first beacon schedule and a second AP, e.g., device 104 (FIG. 1), may schedule beacon transmissions according to the second beacon schedule.

In some demonstrative embodiments, the first beacon schedule may include a first sequence of TBTTs 203 separated by a first predefined BI, and the second beacon schedule may include a second sequence of TBTTs 205 separated by a second predefined BI. For example, as shown in FIG. 2 the first Bi may be equal to the second BI.

In some demonstrative embodiments, at state 200 the sequence of TBTTs 205 may be shifted with respect to the sequence of TBTTs 203. Accordingly, at state 200, a TBTT 203 may not overlap with any TBTT 205. As a result, the first AP, e.g., device 102 (FIG. 1), utilizing the sequence of TBTTs 203, may transmit beacon frames during TBTTs 203; and the second AP, e.g., device 104 (FIG. 1), utilizing the sequence of TBTTs 205, may transmit beacon frames during TBTTs 205.

In some demonstrative embodiments, at state 202 the sequence of TBTTs 205 may partially overlap the sequence of TBTTs 203. In one example, a local clock of device 102 (FIG. 1) may drift faster than a local clock of device 104 (FIG. 1). As a result, a timing of TBTTs 203, as determined by device 102 (FIG. 1), may drift towards a timing of TBTTs 205, as determined by device 104 (FIG. 1), e.g., until the sequence of TBTTs 203 may begin to overlap the sequence of TBTTs 203.

In some demonstrative embodiments, an AP, e.g., device 104 (FIG. 1), utilizing TBTTs 205, may not be able to transmit a beacon during a portion (“the overlapping portion”) of TBTT 205, which is overlapping a portion of TBTT 203, for example, if another AP, e.g., device 102 (FIG. 1), utilizing TBTTs 203, is already using the overlapping portion for transmission of a beacon frame. For example, device 104 (FIG. 1) may have to defer transmission of the beacon frame to a portion (“the non-overlapping portion”) of TBTT 205, which does not overlap with a portion of TBTT 203.

In some demonstrative embodiments, at state 204, the sequence of TBTTs 205 may entirely overlap the sequence of TBTTs 203. In one example, the drift of the local clock of device 102 (FIG. 1) may result in the timing of TBTTs 203, as determined by device 102 (FIG. 1), to drift towards the timing of TBTTs 205, as determined by device 104 (FIG. 1), e.g., until the sequence of TBTTs 203 entirely overlaps the sequence of TBTTs 203.

In some demonstrative embodiments, at state 204, an AP, e.g., device 104 (FIG. 1), utilizing TBTTs 205, may not be able to transmit a beacon during the entirety of TBTT 205, which is overlapping TBTT 203, for example, if another AP, e.g., device 102 (FIG. 1), utilizing TBTTs 203, is already using the overlapping TBTT 203 for transmission of a beacon frame. For example, device 104 (FIG. 1) may have to defer transmission of the beacon frame to a subsequent TBTT 205.

In some demonstrative embodiments, at state 206, the sequence of TBTTs 205 may partially overlap the sequence of TBTTs 203. In one example, the drift of the local clock of device 102 (FIG. 1) may result in the timing of TBTTs 203, as determined by device 102 (FIG. 1), to drift further away from the timing of TBTTs 205 as determined by device 104 (FIG. 1), e.g., until the sequence of TBTTs 203 partially overlaps the sequence of TBTTs 205.

In some demonstrative embodiments, at state 206, an AP, e.g., device 102 (FIG. 1), utilizing TBTTs 203, may not be able to transmit a beacon during a portion (“the overlapping portion”) of TBTT 203, which is overlapping a portion of TBTT 205, for example, if another AP, e.g., device 104 (FIG. 1), utilizing TBTTs 205, is already using the overlapping portion for transmission of a beacon frame. For example, device 102 (FIG. 1) may have to defer transmission of the beacon frame to a portion (“the non-overlapping portion”) of TBTT 203, which does not overlap with a portion of TBTT 205.

Referring back to FIG. 1, in some demonstrative embodiments, a continuous drift of the local clocks of devices 102 and 104 (“the relative clock drift”) may result in a repeated cycling through the states 200, 202, 204 and 206 (FIG. 2), for example, if both devices 102 and 104 utilize the same common BI.

In some demonstrative embodiments, the relative clock drift between devices 102 and 104 may be large enough, e.g., such that the TBTTs utilized by device 102 will not overlap with the TBTTs utilized by device 104, e.g., during at least some duration, for example, during one or more periods of time when the TBTT sequences are at the relative timing state 200 (FIG. 2). However, devices 102 and 104 may suffer multiple collisions between the TBTTs, for example, during one or more periods of time when the TBTT sequences are at the relative timing states 202, 204 and/or 206 (FIG. 2), e.g., until reaching the state 200 at which the TBTTs do not collide.

In some demonstrative embodiments, using a network synchronization protocol, for example, a Network Time Protocol (NTP), to synchronize between the TBTT sequences may only be useful for managed networks, e.g., enterprise deployments. The NTP may not be useful for other networks, e.g., ad-hoc networks and/or dense urban deployments.

In some demonstrative embodiments, device 102 may be configured to reschedule the beacon schedule used by device 102, for example, upon detecting one or more collisions during one or more TBTTs, e.g., as described below.

In some demonstrative embodiments, wireless communication unit 110 may be configured to identify an expected beacon collision and/or potential TBTT overlap, and to select a new scheduling for the beacon transmission, e.g., as described below.

In some demonstrative embodiments, wireless communication unit 110 may notify one or more wireless communication devices of the rescheduling of the beacon transmission, e.g., as described below.

In one example, device 102 may notify device 106, which may be associated with device 102 or may be decoding the beacons from device 102, regarding the rescheduling of the beacon transmission, for example, such that the connectivity of device 106 and/or the ability of device 106 to decode the beacons from device 102 may not be affected.

In one example, devices 102 and 106 may perform the functionality of STAs belonging to a common wireless communication network.

For example, device 102 may perform the functionality of a group owner, and device 106 may perform the functionality of a group client. In another example, device 102 may perform the functionality a PCP/AP STA, and device 106 may perform the functionality of a non-PCP/AP STA, for example, within a network controlled by device 102.

In another example, device 102 may perform the functionality of network controller, e.g., a group owner or a PCP/AP STA of a first network, and device 106 may perform the functionality of a STA belonging to a second network. For example, device 106 may perform the functionality of a group owner or PCP/AP STA of the second network. In another example, device 106 may perform the functionality of a group client or non-PCP/AP STA of the second network.

In some demonstrative embodiments, wireless communication unit 110 may schedule transmissions of beacon frames according to a first beacon schedule including a first sequence of beacon transmission times separated by a predefined beacon interval period, denoted Δt. For example, wireless communication unit 110 may schedule the transmission of the beacon frames according to the beacon scheme including TBTTs 203 (FIG. 2), as described above.

In some demonstrative embodiments, wireless communication unit 110 may be able to reschedule broadcasting of the beacons from the first beacon schedule to a second beacon schedule, e.g., as described in detail below.

In some demonstrative embodiments, wireless communication unit 110 may determine to reschedule the beacons to the second beacons schedule, for example, based on one or more predefined rescheduling criteria, e.g., as described below.

In some demonstrative embodiments, the rescheduling criteria may be configured, for example, to detect a possibility that the first beacon transmission times of the first beacon schedule may at least partially overlap one or more other beacon transmission times utilized by another device, e.g., device 104 (FIG. 1). For example, the rescheduling criteria may be configured to reschedule the transmission of the beacons, when TBTTs 203 (FIG. 2) at least partially overlap TBTTs 205 (FIG. 2), e.g., as described above.

In some demonstrative embodiments, wireless communication unit 110 may reschedule the broadcasting of the beacons according to the second beacon schedule, for example, when the first sequence of beacon transmission times at least partially overlaps one or more beacons received by wireless communication device 110.

In some demonstrative embodiments, wireless communication unit 110 may reschedule the broadcasting of the beacons according to the second beacon schedule, for example, when wireless communication medium 103 is occupied during at least a predefined time period beginning at a beacon transmission time of the first sequence of beacon transmission times.

In some demonstrative embodiments, wireless communication unit 110 may reschedule the broadcasting of the beacons according to the second beacon schedule, for example, when detecting a collision with a beacon from another device.

In one example, wireless communication unit 110 may utilize a Carrier Sense Multiple Access (CSMA) mechanism to access wireless communication medium 103. According to this example, wireless communication unit 110 may reschedule the broadcasting of the beacons according to the second beacon schedule, for example, when wireless communication unit 110 is to back off from accessing wireless communication medium 103, e.g., during a TBTT 203 (FIG. 2), according to the CSMA mechanism. For example, wireless communication unit 110 is to back off from accessing wireless communication medium 103, for example, when the timing of TBTT 203 (FIG. 2) is at the relative timing state 202, 204 or 206 (FIG. 2).

In some demonstrative embodiments, wireless communication unit 110 may reschedule the broadcasting of the beacons according to the second beacon schedule, for example, if wireless communication unit 110 is unable to transmit a beacon frame at a TBTT of the first beacon schedule. For example, wireless communication unit 110 is to back off from accessing wireless communication medium 103, for example, when the timing of TBTT 203 (FIG. 2) is at the relative timing state 204 (FIG. 2).

In some demonstrative embodiments, wireless communication unit 110 may reschedule the broadcasting of the beacons according to the second beacon schedule, for example, when an actual transmission of a predefined number of beacons according to the first beacon schedule is delayed by at least a predefined period of time.

In one example, wireless communication unit 110 may reschedule the broadcasting of the beacons according to the second beacon schedule, for example, when two consecutive beacon transmissions are each delayed, e.g., with respect to a respective TBTT, by a delay period greater than a predefined delay threshold, e.g., 200 microseconds.

In other embodiments, wireless communication unit 110 may reschedule the broadcasting of the beacons according to the second beacon schedule according to any other additional or alternative criterion.

In some demonstrative embodiments, the second beacon schedule may include a second sequence of beacon transmission times separated by the predefined beacon interval period Δt. The second sequence of beacon transmission times may be shifted from the first beacon transmission times by a delay period, e.g., as described below. In other embodiments, the second sequence of beacon transmission times may be and/or shifted with respect to the sequence of beacon transmission times using any other beacon interval period, any other delay or shift period, and/or any other delay and/or shifting mechanism.

In some demonstrative embodiments, the delay period, denoted Δt₀, may be shorter than the beacon interval period Δt. For example, using the delay period Δt₀, which is shorter than the beacon interval period Δt, may increase the probability that a TBTT of the second beacon schedule does not coincide or overlap with a TBTT of the first beacon schedule.

In some demonstrative embodiments, wireless communication unit 110 may determine delay period Δt₀ according to one or more mechanisms, e.g., as described below.

In some demonstrative embodiments, wireless communication unit 110 may determine delay period Δt₀ based on a shift between the first sequence of beacon transmission times and a sequence of beacons (“the received sequence of beacons”) received and/or detected by wireless communication unit 110.

In one example, wireless communication unit 110 may determine a relative clock drift based on the shift between the first sequence of beacon transmission times and the received sequence of beacons.

For example, wireless communication unit 110 may determine delay period Δt₀ based on the relative clock drift, for example, to maximize a time period until a next expected collision between a TBTT of the second beacon schedule and the received sequence of beacons.

In some demonstrative embodiments, wireless communication unit 110 may randomly select delay period Δt₀.

In one example, wireless communication unit 110 may randomly select delay period Δt₀ from a predefined range, e.g., the range of [(0.1*Δt),(0.9*Δt)].

In other embodiments, wireless communication unit 110 may determine delay period Δt₀ based on any additional or alternative mechanism.

In some demonstrative embodiments, system 100 may be configured to enable centric scheduling of the beacon schedules for devices 102 and/or 104, e.g., as described below.

In some demonstrative embodiments, system 100 may include a server 199, which may communicate with APs within system 100, e.g., devices 102 and/or 104, to collect the beacon schedules utilized by the APs.

In some demonstrative embodiments, server 199 may identify one or more potential TBTT collisions, for example, based on the collected beacons schedules. Server 199 may control one or more of the APs to reschedule the beacon transmissions, e.g., as described above.

In some demonstrative embodiments, server 199 may be implemented as a dedicated element of system 100. In other embodiments, an AP, e.g., device 102, may perform the functionality of server 199 to control one or more other devices, e.g., device 104.

In some demonstrative embodiments, wireless communication unit 110 may transmit at least one information element including timing information of the second beacon schedule.

In some demonstrative embodiments, wireless communication unit 110 may transmit the information element prior to switching to broadcast one or more beacons according to the second beacon schedule.

In some demonstrative embodiments, wireless communication unit 110 may advertise the timing of the second beacon schedule, for example, by transmitting the information element as part of a broadcast message, a dedicated message, a unicast message, a multicast message and/or any other message, e.g., as described below.

In some demonstrative embodiments, wireless communication unit 110 may broadcast the information element including timing information of the second beacon schedule.

For example, wireless communication unit may broadcast the information element as part of at least one beacon.

In some demonstrative embodiments, wireless communication unit 110 may transmit the information element as part of a Delivery Traffic Indication Message (DTIM), which may be included as part of one or more beacon frames.

In some demonstrative embodiments, wireless communication unit 110 may transmit the information element as part of a dedicated management frame. For example, wireless communication unit 110 may broadcast a dedicated management frame including the information element to be received by one or more connected clients of device 102, e.g., device 106.

In some demonstrative embodiments, wireless communication unit 110 may transmit the information element as part of a probe response. For example, wireless communication unit 110 may transmit the probe response frame to a connected client of device 102, e.g., device 106.

In some demonstrative embodiments, wireless communication unit 110 may repeat the transmission of the information element for a predefined number of times, e.g., to increase a probability of most or all client devices receiving the information element, e.g., prior to wireless communication unit 110 switching to transmit the beacon frames according to the second beacon schedule.

In one example, wireless communication unit 110 may repeatedly transmit information element as part of beacons, which may be broadcasted a predefined number of TBTTs of the first beacon schedule, prior to switching to the second beacons schedule. For example, wireless communication unit 110 may transmit information element as part of three beacons prior to switching to the second beacons schedule.

In some demonstrative embodiments, wireless communication unit 110 may transmit the information element including the timing information of the second beacon schedule via a dedicated backhaul channel, which may be established between wireless communication unit 110 and one or more other devices of system 100, e.g., one or more other APs.

In one example, a wireless backhaul network may be established between device 102 and one or more other devices of system 100, e.g., device 104. Any other distribution and/or backhaul network, e.g., utilizing wired and/or wireless channels may be utilized to communicate the information element including the timing information of the second beacon schedule.

In some demonstrative embodiments, the information element may include a value of the delay period Δt₀.

In some demonstrative embodiments, the information element may include any other value indicative of a timing at which the second beacon schedule is to begin.

In some demonstrative embodiments, the information element may include timing at which the second beacon schedule is to begin using a shred clock, which may be shared by one or more devices of system 100. For example, the shared cock may include an external network shared clock, a cellular network clock, a Global navigation Satellite System (GNSS) clock, a synchronized shared clock, and the like.

In other embodiments, the information element may include timing at which the second beacon schedule is to begin expressed in terms of a local clock of device 102.

In one example, the information element may include an absolute timing, e.g., in terms of a Time Synchronization Function (TSF) of device 102, a Coordinated Universal Time (UTC), a Global Positioning System (GPS) time, and the like.

In another example, the information element may include a relative timing at which the second beacon schedule is to begin. For example, the information element may include a first timing value representing delay period Δt₀, and a second timing value representing a timing at which the delay period Δt₀ is to be applied.

For example, the information element may indicate that the second beacon schedule will be shifted by 50 milliseconds within 30 milliseconds from a transmission time of the information element.

For example, wireless communication unit 110 may transmit the information element as part of a sequence of transmissions, e.g., as described above. Wireless communication unit 110 may include in each information element a countdown value representing a remaining time until switching to the second beacon schedule.

In some demonstrative embodiments, wireless communication unit 105 may receive one or more beacons from device 102 according to the first beacon schedule.

In some demonstrative embodiments, wireless communication unit 105 may receive the information element including the timing information of the second beacon schedule, e.g., from device 102.

In some demonstrative embodiments, wireless communication unit 105 may reschedule receipt of subsequent beacons according to the second beacon schedule.

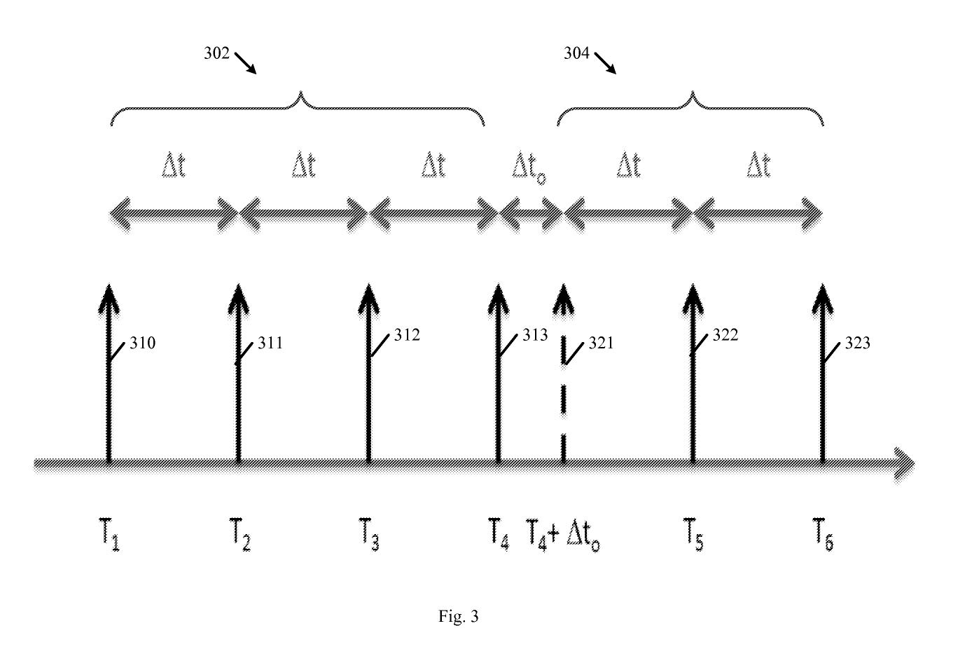

Reference is made to FIG. 3, which schematically illustrates a first beacon schedule 302 and a second beacon schedule 304, in accordance with some demonstrative embodiments. For example, wireless communication unit 110 (FIG. 1) may reschedule broadcasting of beacon frames from beacon schedule 302 to beacon schedule 304, e.g., as described above.

In some demonstrative embodiments, wireless communication unit 110 (FIG. 1) may schedule beacon frames to be broadcast according to beacon schedule 302.

In some demonstrative embodiments, beacon schedule 302 may include, for example, a plurality of TBTTs, e.g., including a TBTT 310 at a time T₁, a TBTT 311 at a time T₂, a TBTT 312 at a time T₃, and a TBTT 313 at a time T₄.

In some demonstrative embodiments, each pair of consecutive TBTTs 310, 311, 312 and 313 may be separated by the beacon interval Δt.

In some demonstrative embodiments, wireless communication unit 110 (FIG. 1) may reschedule the beacon frames to be broadcast according to beacon schedule 304.

In some demonstrative embodiments, wireless communication unit 110 (FIG. 1) may select to reschedule the transmission of the beacon frames, based on one or more rescheduling criteria. For example, wireless communication unit 110 (FIG. 1) may select to reschedule the transmission of the beacon frames, for example, upon determining that one or more TBTTs of beacon schedule 302 may potentially overlap with TBTTs of another device, e.g., device 104 (FIG. 1), as described above.

In some demonstrative embodiments, wireless communication unit 110 (FIG. 1) may determine beacon schedule 304 to begin after the time T₄ and to be shifted from beacon schedule 302 by delay period Δtₒ. For example, as shown in FIG. 3, beacon schedule 304 may begin at a time T₄+Δtₒ. Beacon schedule 304 may include, for example, a plurality of TBTTs, e.g., including a TBTT 321 at the time T₄+Δtₒ, a TBTT 322 at a time T₅, and a TBTT 323 at a time T₆. Alternatively, Beacon schedule 304 may begin at the time T₅, e.g., while skipping the time T₄+Δtₒ.

In some demonstrative embodiments, each pair of consecutive TBTTs 321, 322 and 323 may be separated by the beacon interval Δt.

In some demonstrative embodiments, wireless communication unit 110 (FIG. 1) may transmit an information element indicating the time T₄+Δtₒ at which wireless communication unit 110 (FIG. 1) is to switch to broadcast beacons according to beacon schedule 304.

In some demonstrative embodiments, wireless communication unit 110 (FIG. 1) may transmit the information element for a predefined number of times prior to switching to broadcast beacons according to beacon schedule 304, e.g., as described above.

In one example, wireless communication unit 110 (FIG. 1) may successfully transmit a beacon frame at TBTT 310. Wireless communication unit 110 (FIG. 1) may select to reschedule the beacon transmissions according to beacon schedule 304, for example, when wireless communication unit 110 (FIG. 1) detects another beacon transmission at TBTT 311.

According to this example, wireless communication unit 110 (FIG. 1) may broadcast beacons at TBTT 312 and TBTT 314, each beacon including the information element indicating the time T₄+Δtₒ at which wireless communication unit 110 (FIG. 1) is to switch to broadcast beacons according to beacon schedule 304.

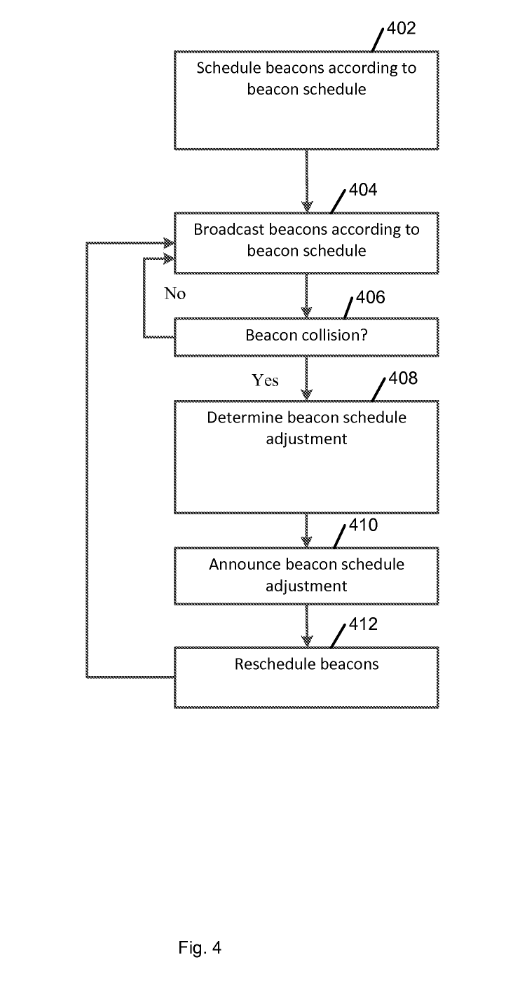

Reference is made to FIG. 4, which schematically illustrates a method of scheduling beacon transmissions, in accordance with some demonstrative embodiments. For example, one or more operations of the method of FIG. 4 may be performed by one or more elements of a system, e.g., system 100 (FIG. 1), a wireless communication device, e.g., wireless communication devices 102, 104, 106 and/or 108 (FIG. 1), and/or wireless communication unit, e.g., wireless communication units 110 and/or 120 (FIG. 1).

As indicated at block 402, the method may include scheduling beacons for broadcasting according to a beacon schedule. For example, wireless communication device 102 (FIG. 1) may scheduling one of more beacons for broadcasting according to beacon schedule 302 (FIG. 3), e.g., as described above.

As indicated at block 404, the method may include broadcasting one or more first beacons according to the beacon schedule. For example, wireless communication device 102 (FIG. 1) may broadcast one of more beacons according to beacon schedule 302 (FIG. 3), e.g., as described above.

As indicated at block 406, the method may include determining whether one or more beacon transmission times of the beacon schedule may result in beacon collisions. For example, wireless communication device 102 (FIG. 1) may determine whether one or more TBTTs of beacon schedule 302 (FIG. 3) may result in beacon collision, e.g., as described above.

As indicated at block 408, the method may include determining an adjustment to the beacon schedule, e.g., if the one or more beacon transmission times of the beacon schedule may result in beacon collisions. For example, wireless communication device 102 may determine a delay period to be applied to beacon schedule 302 (FIG. 3), e.g., as described above.

As indicated at block 410, the method may include transmitting at least one announcement of the beacon schedule announcement. For example, wireless communication device 102 (FIG. 1) may transmit at least one information element including timing information of beacon schedule 304 (FIG. 3), e.g., as described above.

As indicated at block 412, the method may include rescheduling broadcasting of one or more beacons according to the adjusted beacon schedule. For example, wireless communication device 102 (FIG. 1) may broadcast one of more beacons according to beacon schedule 304 (FIG. 3), for example, after transmitting the information element, e.g., as described above.

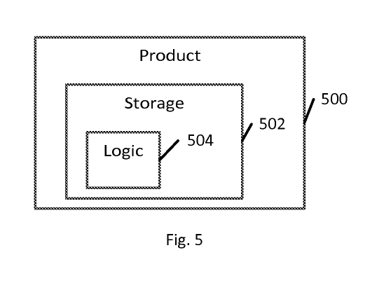

Reference is made to FIG. 5, which schematically illustrates a product of manufacture 800, in accordance with some demonstrative embodiments. Product 500 may include a non-transitory machine-readable storage medium 502 to store logic 504, which may be used, for example, to perform at least part of the functionality of device 102 (FIG. 1), device 104 (FIG. 1), device 106 (FIG. 1), device 108 (FIG. 1), wireless communication unit 110 (FIG. 1), wireless communication unit 120 (FIG. 1), and/or to perform one or more operations of the method of FIG. 4. The phrase “non-transitory machine-readable medium” is directed to include all computer-readable media, with the sole exception being a transitory propagating signal.

In some demonstrative embodiments, product 500 and/or machine-readable storage medium 502 may include one or more types of computer-readable storage media capable of storing data, including volatile memory, non-volatile memory, removable or non-removable memory, erasable or non-erasable memory, writeable or re-writeable memory, and the like. For example, machine-readable storage medium 502 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative embodiments, logic 504 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 504 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

### EXAMPLES

The following examples pertain to further embodiments.

Example 1 includes an apparatus of wireless communication, the apparatus comprising a wireless communication unit to reschedule broadcasting of a plurality of beacons from a first beacon schedule to a second beacon schedule, the first beacon schedule including a first sequence of beacon transmission times separated by a predefined beacon interval period, and the second beacon schedule including a second sequence of beacon transmission times separated by the predefined beacon interval period, the second sequence of beacon transmission times being shifted from the first beacon transmission times by a delay period, and wherein the wireless communication unit is to transmit at least one information element including timing information of the second beacon schedule.

Example 2 includes the subject matter of Example 1, and optionally, wherein the wireless communication unit is to transmit the information element prior to broadcasting one or more beacons according to the second beacon schedule.

Example 3 includes the subject matter of Example 1 or 2, and optionally, wherein the wireless communication unit is to reschedule the broadcasting of the beacons according to the second beacon schedule when the wireless communication unit is to back off transmission of one or more beacons at one or more beacon transmission times of the first sequence of beacon transmission times.

Example 4 includes the subject matter of any one of Examples 1-3, and optionally, wherein the wireless communication unit is to reschedule the broadcasting of the beacons according to the second beacon schedule when an actual transmission of a predefined number of beacons according to the first beacon schedule is delayed by at least a predefined period of time.

Example 5 includes the subject matter of any one of Examples 1-4, and optionally, wherein the wireless communication unit is to broadcast the plurality of beacons over a wireless communication medium, and wherein the wireless communication unit is to reschedule the broadcasting of the beacons according to the second beacon schedule when the wireless communication medium is occupied during at least a predefined time period beginning at a beacon transmission time of the first sequence of beacon transmission times.

Example 6 includes the subject matter of any one of Examples 1-5, and optionally, wherein the wireless communication unit is to reschedule the broadcasting of the beacons according to the second beacon schedule when the first sequence of beacon transmission times at least partially overlaps one or more beacons received by the wireless communication device.

Example 7 includes the subject matter of any one of Examples 1-6, and optionally, wherein the wireless communication unit is to broadcast the information element as part of at least one beacon.

Example 8 includes the subject matter of any one of Examples 1-6, and optionally, wherein the wireless communication unit is to transmit the information element as part of a dedicated management frame.

Example 9 includes the subject matter of any one of Examples 1-6, and optionally, wherein the wireless communication unit is to transmit the information element as part of a probe response.

Example 10 includes the subject matter of any one of Examples 1-6, and optionally, wherein the wireless communication unit is to transmit the information element over a backhaul channel connecting the wireless communication unit to one or more network controllers.

Example 11 includes the subject matter of any one of Examples 1-10, and optionally, wherein the information element includes a value of the delay period.

Example 12 includes the subject matter of any one of Examples 1-10, and optionally, wherein the information element includes a time at which the second beacon schedule is to begin.

Example 13 includes the subject matter of any one of Examples 1-12, and optionally, wherein the wireless communication unit is to determine the delay period based on a shift between the first sequence of beacon transmission times and a sequence of beacons received by the wireless communication unit.

Example 14 includes the subject matter of any one of Examples 1-12, and optionally, wherein the wireless communication unit is to randomly select the delay period.

Example 15 includes the subject matter of any one of Examples 1-14, and optionally, wherein the delay period is shorter than the beacon interval period.

Example 16 includes a system of wireless communication, the system comprising an access point (AP) including one or more antennas; and a wireless communication unit to reschedule broadcasting of a plurality of beacons from a first beacon schedule to a second beacon schedule, the first beacon schedule including a first sequence of beacon transmission times separated by a predefined beacon interval period, and the second beacon schedule including a second sequence of beacon transmission times separated by the predefined beacon interval period, the second sequence of beacon transmission times being shifted from the first beacon transmission times by a delay period, and wherein the wireless communication unit is to transmit at least one information element including timing information of the second beacon schedule.

Example 17 includes the subject matter of Example 16, and optionally, wherein the wireless communication unit is to transmit the information element prior to broadcasting one or more beacons according to the second beacon schedule.

Example 18 includes the subject matter of Example 16 or 17, and optionally, wherein the wireless communication unit is to reschedule the broadcasting of the beacons according to the second beacon schedule when the wireless communication unit is to back off transmission of one or more beacons at one or more beacon transmission times of the first sequence of beacon transmission times.

Example 19 includes the subject matter of any one of Examples 16-18, and optionally, wherein the wireless communication unit is to reschedule the broadcasting of the beacons according to the second beacon schedule when an actual transmission of a predefined number of beacons according to the first beacon schedule is delayed by at least a predefined period of time.

Example 20 includes the subject matter of any one of Examples 16-19, and optionally, wherein the wireless communication unit is to broadcast the plurality of beacons over a wireless communication medium, and wherein the wireless communication unit is to reschedule the broadcasting of the beacons according to the second beacon schedule when the wireless communication medium is occupied during at least a predefined time period beginning at a beacon transmission time of the first sequence of beacon transmission times.

Example 21 includes the subject matter of any one of Examples 16-20, and optionally, wherein the wireless communication unit is to reschedule the broadcasting of the beacons according to the second beacon schedule when the first sequence of beacon transmission times at least partially overlaps one or more beacons received by the wireless communication device.

Example 22 includes the subject matter of any one of Examples 16-21, and optionally, wherein the wireless communication unit is to broadcast the information element as part of at least one beacon.

Example 23 includes the subject matter of any one of Examples 16-21, and optionally, wherein the wireless communication unit is to transmit the information element as part of a dedicated management frame.

Example 24 includes the subject matter of any one of Examples 16-21, and optionally, wherein the wireless communication unit is to transmit the information element as part of a probe response.

Example 25 includes the subject matter of any one of Examples 16-21, and optionally, wherein the wireless communication unit is to transmit the information element over a backhaul channel between the AP and one or more other APs.

Example 26 includes the subject matter of any one of Examples 16-25, and optionally, wherein the information element includes a value of the delay period.

Example 27 includes the subject matter of any one of Examples 16-26, and optionally, wherein the information element includes a time at which the second beacon schedule is to begin.

Example 28 includes the subject matter of any one of Examples 16-27, and optionally, wherein the wireless communication unit is to determine the delay period based on a shift between the first sequence of beacon transmission times and a sequence of beacons received by the wireless communication unit.

Example 29 includes the subject matter of any one of Examples 16-27, and optionally, wherein the wireless communication unit is to randomly select the delay period.

Example 30 includes the subject matter of any one of Examples 16-29, and optionally, wherein the delay period is shorter than the beacon interval period.

Example 31 includes a method of wireless communication, the method comprising broadcasting one or more first beacons according to a first schedule including a first sequence of beacon transmission times separated by a predefined beacon interval period; determining a second schedule including a second sequence of beacon transmission times separated by the predefined beacon interval period, the second sequence of beacon transmission times being shifted from the first beacon transmission times by a delay period; and transmitting at least one information element including timing information of the second sequence.

Example 32 includes the subject matter of Example 31, and optionally, comprising transmitting the information element prior to broadcasting one or more beacons according to the second beacon schedule.

Example 33 includes the subject matter of Example 31 or 32, and optionally, comprising rescheduling the broadcasting of the beacons according to the second beacon schedule when transmission of one or more beacons is to be backed off from one or more beacon transmission times of the first sequence of beacon transmission times.

Example 34 includes the subject matter of any one of Examples 31-33, and optionally, comprising rescheduling the broadcasting of the beacons according to the second beacon schedule when an actual transmission of a predefined number of beacons according to the first beacon schedule is delayed by at least a predefined period of time.

Example 35 includes the subject matter of any one of Examples 31-34, and optionally, comprising broadcasting the plurality of beacons over a wireless communication medium, and rescheduling the broadcasting of the beacons according to the second beacon schedule when the wireless communication medium is occupied during at least a predefined time period beginning at a beacon transmission time of the first sequence of beacon transmission times.

Example 36 includes the subject matter of any one of Examples 31-35, and optionally, comprising rescheduling the broadcasting of the beacons according to the second beacon schedule when the first sequence of beacon transmission times at least partially overlaps one or more received beacons.

Example 37 includes the subject matter of any one of Examples 31-36, and optionally, comprising broadcasting the information element as part of at least one beacon.

Example 38 includes the subject matter of any one of Examples 31-36, and optionally, comprising transmitting the information element as part of a dedicated management frame.

Example 39 includes the subject matter of any one of Examples 31-36, and optionally, comprising transmitting the information element as part of a probe response.

Example 40 includes the subject matter of any one of Examples 31-36, and optionally, comprising transmitting the information element over a backhaul channel between two or more network controllers.

Example 41 includes the subject matter of any one of Examples 31-40, and optionally, wherein the information element includes a value of the delay period.

Example 42 includes the subject matter of any one of Examples 31-41, and optionally, wherein the information element includes a time at which the second beacon schedule is to begin.

Example 43 includes the subject matter of any one of Examples 31-42, and optionally, comprising determining the delay period based on a shift between the first sequence of beacon transmission times and a sequence of received beacons.

Example 44 includes the subject matter of any one of Examples 31-42, and optionally, comprising randomly selecting the delay period.

Example 45 includes the subject matter of any one of Examples 31-44, and optionally, wherein the delay period is shorter than the beacon interval period.

Example 46 includes a product including a non-transitory storage medium having stored thereon instructions that, when executed by a machine, result in broadcasting one or more first beacons according to a first schedule including a first sequence of beacon transmission times separated by a predefined beacon interval period; determining a second schedule including a second sequence of beacon transmission times separated by the predefined beacon interval period, the second sequence of beacon transmission times being shifted from the first beacon transmission times by a delay period; and transmitting at least one information element including timing information of the second sequence.

Example 47 includes the subject matter of Example 46, and optionally, wherein the instructions result in transmitting the information element prior to broadcasting one or more beacons according to the second beacon schedule.

Example 48 includes the subject matter of Example 46 or 47, and optionally, wherein the instructions result in rescheduling the broadcasting of the beacons according to the second beacon schedule when transmission of one or more beacons is to be backed off from one or more beacon transmission times of the first sequence of beacon transmission times.

Example 49 includes the subject matter of any one of Examples 46-48, and optionally, wherein the instructions result in rescheduling the broadcasting of the beacons according to the second beacon schedule when an actual transmission of a predefined number of beacons according to the first beacon schedule is delayed by at least a predefined period of time.

Example 50 includes the subject matter of any one of Examples 46-49, and optionally, wherein the instructions result in broadcasting the plurality of beacons over a wireless communication medium, and rescheduling the broadcasting of the beacons according to the second beacon schedule when the wireless communication medium is occupied during at least a predefined time period beginning at a beacon transmission time of the first sequence of beacon transmission times.

Example 51 includes the subject matter of any one of Examples 46-50, and optionally, wherein the instructions result in rescheduling the broadcasting of the beacons according to the second beacon schedule when the first sequence of beacon transmission times at least partially overlaps one or more received beacons.

Example 52 includes the subject matter of any one of Examples 46-51, and optionally, wherein the instructions result in broadcasting the information element as part of at least one beacon.

Example 53 includes the subject matter of any one of Examples 46-51, and optionally, wherein the instructions result in transmitting the information element as part of a dedicated management frame.

Example 54 includes the subject matter of any one of Examples 46-51, and optionally, wherein the instructions result in transmitting the information element as part of a probe response.

Example 55 includes the subject matter of any one of Examples 46-51, and optionally, wherein the instructions result in transmitting the information element over a backhaul channel between two or more network controllers.

Example 56 includes the subject matter of any one of Examples 46-55, and optionally, wherein the information element includes a value of the delay period.

Example 57 includes the subject matter of any one of Examples 46-56, and optionally, wherein the information element includes a time at which the second beacon schedule is to begin.

Example 58 includes the subject matter of any one of Examples 46-57, and optionally, wherein the instructions result in determining the delay period based on a shift between the first sequence of beacon transmission times and a sequence of received beacons.

Example 59 includes the subject matter of any one of Examples 46-57, and optionally, wherein the instructions result in randomly selecting the delay period.

Example 60 includes the subject matter of any one of Examples 46-59, and optionally, wherein the delay period is shorter than the beacon interval period.

Example 61 includes an apparatus of wireless communication, the apparatus comprising means for broadcasting one or more first beacons according to a first schedule including a first sequence of beacon transmission times separated by a predefined beacon interval period; means for determining a second schedule including a second sequence of beacon transmission times separated by the predefined beacon interval period, the second sequence of beacon transmission times being shifted from the first beacon transmission times by a delay period; and means for transmitting at least one information element including timing information of the second sequence.

Example 62 includes the subject matter of Example 61, and optionally, comprising means for transmitting the information element prior to broadcasting one or more beacons according to the second beacon schedule.

Example 63 includes the subject matter of Example 61 or 62, and optionally, comprising means for rescheduling the broadcasting of the beacons according to the second beacon schedule when transmission of one or more beacons is to be backed off from one or more beacon transmission times of the first sequence of beacon transmission times.

Example 64 includes the subject matter of any one of Examples 61-63, and optionally, comprising means for rescheduling the broadcasting of the beacons according to the second beacon schedule when an actual transmission of a predefined number of beacons according to the first beacon schedule is delayed by at least a predefined period of time.

Example 65 includes the subject matter of any one of Examples 61-64, and optionally, comprising means for broadcasting the plurality of beacons over a wireless communication medium, and rescheduling the broadcasting of the beacons according to the second beacon schedule when the wireless communication medium is occupied during at least a predefined time period beginning at a beacon transmission time of the first sequence of beacon transmission times.

Example 66 includes the subject matter of any one of Examples 61-65, and optionally, comprising means for rescheduling the broadcasting of the beacons according to the second beacon schedule when the first sequence of beacon transmission times at least partially overlaps one or more received beacons.

Example 67 includes the subject matter of any one of Examples 61-66, and optionally, comprising means for broadcasting the information element as part of at least one beacon.

Example 68 includes the subject matter of any one of Examples 61-66, and optionally, comprising means for transmitting the information element as part of a dedicated management frame.

Example 69 includes the subject matter of any one of Examples 61-66, and optionally, comprising means for transmitting the information element as part of a probe response.

Example 70 includes the subject matter of any one of Examples 61-66, and optionally, comprising means for transmitting the information element over a backhaul channel between two or more network controllers.

Example 71 includes the subject matter of any one of Examples 61-70, and optionally, wherein the information element includes a value of the delay period.

Example 72 includes the subject matter of any one of Examples 61-71, and optionally, wherein the information element includes a time at which the second beacon schedule is to begin.

Example 73 includes the subject matter of any one of Examples 61-72, and optionally, comprising means for determining the delay period based on a shift between the first sequence of beacon transmission times and a sequence of received beacons.

Example 74 includes the subject matter of any one of Examples 61-72, and optionally, comprising means for randomly selecting the delay period.

Example 75 includes the subject matter of any one of Examples 61-74, and optionally, wherein the delay period is shorter than the beacon interval period.

Example 76 includes an apparatus of wireless communication, the apparatus comprising a wireless communication unit to receive one or more beacons according to a first beacon schedule including a first sequence of beacon transmission times separated by a predefined beacon interval period, the wireless communication unit to receive at least one information element including timing information of a second beacon schedule including a second sequence of beacon transmission times separated by the predefined beacon interval period, the second sequence of beacon transmission times being shifted from the first beacon transmission times by a delay period, wherein the wireless communication unit is to receive one or more subsequent beacons according to the second beacon schedule.

Example 77 includes the subject matter of Example 76, and optionally, wherein the wireless communication unit is to receive the information element as part of at least one beacon.

Example 78 includes the subject matter of Example 76, and optionally, wherein the wireless communication unit is to receive the information element as part of a dedicated management frame.

Example 79 includes the subject matter of Example 76, and optionally, wherein the wireless communication unit is to receive the information element as part of a probe response.

Example 80 includes the subject matter of any one of Examples 76-79, and optionally, wherein the information element includes a value of the delay period.

Example 81 includes the subject matter of any one of Examples 76-80, and optionally, wherein the information element includes a time at which the second beacon schedule is to begin.

Example 82 includes the subject matter of any one of Examples 76-81, and optionally, wherein the delay period comprises a random delay period.

Example 83 includes the subject matter of any one of Examples 76-82, and optionally, wherein the delay period is shorter than the beacon interval period.

Example 84 includes a system of wireless communication, the system comprising a wireless communication device including at least one antenna; a memory; a processor; and a wireless communication unit to receive via the at least one antenna one or more beacons according to a first beacon schedule including a first sequence of beacon transmission times separated by a predefined beacon interval period, the wireless communication unit to receive at least one information element including timing information of a second beacon schedule including a second sequence of beacon transmission times separated by the predefined beacon interval period, the second sequence of beacon transmission times being shifted from the first beacon transmission times by a delay period, wherein the wireless communication unit is to receive one or more subsequent beacons according to the second beacon schedule.

Example 85 includes the subject matter of Example 84, and optionally, wherein the wireless communication unit is to receive the information element as part of at least one beacon.

Example 86 includes the subject matter of Example 84, and optionally, wherein the wireless communication unit is to receive the information element as part of a dedicated management frame.

Example 87 includes the subject matter of Example 84, and optionally, wherein the wireless communication unit is to receive the information element as part of a probe response.

Example 88 includes the subject matter of any one of Examples 84-87, and optionally, wherein the information element includes a value of the delay period.

Example 89 includes the subject matter of any one of Examples 84-88, and optionally, wherein the information element includes a time at which the second beacon schedule is to begin.

Example 90 includes the subject matter of any one of Examples 84-89, and optionally, wherein the delay period comprises a random delay period.

Example 91 includes the subject matter of any one of Examples 84-90, and optionally, wherein the delay period is shorter than the beacon interval period.

Example 92 includes an method of wireless communication, the method comprising receiving one or more beacons according to a first beacon schedule including a first sequence of beacon transmission times separated by a predefined beacon interval period; receiving at least one information element including timing information of a second beacon schedule including a second sequence of beacon transmission times separated by the predefined beacon interval period, the second sequence of beacon transmission times being shifted from the first beacon transmission times by a delay period; and receiving one or more subsequent beacons according to the second beacon schedule.

Example 93 includes the subject matter of Example 92, and optionally, comprising receiving the information element as part of at least one beacon.

Example 94 includes the subject matter of Example 92, and optionally, comprising receiving the information element as part of a dedicated management frame.

Example 95 includes the subject matter of Example 92, and optionally, comprising receiving the information element as part of a probe response.

Example 96 includes the subject matter of any one of Examples 92-95, and optionally, wherein the information element includes a value of the delay period.

Example 97 includes the subject matter of any one of Examples 92-96, and optionally, wherein the information element includes a time at which the second beacon schedule is to begin.

Example 98 includes the subject matter of any one of Examples 92-97, and optionally, wherein the delay period comprises a random delay period.

Example 99 includes the subject matter of any one of Examples 92-98, and optionally, wherein the delay period is shorter than the beacon interval period.

Example 100 includes a product including a non-transitory storage medium having stored thereon instructions that, when executed by a machine, result in receiving one or more beacons according to a first beacon schedule including a first sequence of beacon transmission times separated by a predefined beacon interval period; receiving at least one information element including timing information of a second beacon schedule including a second sequence of beacon transmission times separated by the predefined beacon interval period, the second sequence of beacon transmission times being shifted from the first beacon transmission times by a delay period; and receiving one or more subsequent beacons according to the second beacon schedule.

Example 101 includes the subject matter of Example 100, and optionally, wherein the instructions result in receiving the information element as part of at least one beacon.

Example 102 includes the subject matter of Example 100, and optionally, wherein the instructions result in receiving the information element as part of a dedicated management frame.

Example 103 includes the subject matter of Example 100, and optionally, wherein the instructions result in receiving the information element as part of a probe response.

Example 104 includes the subject matter of any one of Examples 100-103, and optionally, wherein the information element includes a value of the delay period.

Example 105 includes the subject matter of any one of Examples 100-104, and optionally, wherein the information element includes a time at which the second beacon schedule is to begin.

Example 106 includes the subject matter of any one of Examples 100-105, and optionally, wherein the delay period comprises a random delay period.

Example 107 includes the subject matter of any one of Examples 100-106, and optionally, wherein the delay period is shorter than the beacon interval period.

Example 108 includes an apparatus of wireless communication, the apparatus comprising means for receiving one or more beacons according to a first beacon schedule including a first sequence of beacon transmission times separated by a predefined beacon interval period; means for receiving at least one information element including timing information of a second beacon schedule including a second sequence of beacon transmission times separated by the predefined beacon interval period, the second sequence of beacon transmission times being shifted from the first beacon transmission times by a delay period; and means for receiving one or more subsequent beacons according to the second beacon schedule.

Example 109 includes the subject matter of Example 109, and optionally, comprising means for receiving the information element as part of at least one beacon.

Example 110 includes the subject matter of Example 109, and optionally, comprising means for receiving the information element as part of a dedicated management frame.

Example 111 includes the subject matter of Example 109, and optionally, comprising means for receiving the information element as part of a probe response.

Example 112 includes the subject matter of any one of Examples 109-111, and optionally, wherein the information element includes a value of the delay period.

Example 113 includes the subject matter of any one of Examples 109-112, and optionally, wherein the information element includes a time at which the second beacon schedule is to begin.

Example 114 includes the subject matter of any one of Examples 109-113, and optionally, wherein the delay period comprises a random delay period.

Example 115 includes the subject matter of any one of Examples 109-114, and optionally, wherein the delay period is shorter than the beacon interval period.

While certain features have been illustrated and described herein, many modifications, substitutions, changes, and equivalents may occur to those skilled in the art. It is, therefore, to be understood that the appended claims are intended to cover all such modifications and changes as fall within the true spirit of the invention.

1.-25. (canceled)

26. An apparatus comprising:
a wireless communication unit to reschedule broadcasting of a plurality of beacons from a first beacon schedule to a second beacon schedule, the first beacon schedule including a first sequence of beacon transmission times separated by a predefined beacon interval period, and the second beacon schedule including a second sequence of beacon transmission times separated by said predefined beacon interval period, said second sequence of beacon transmission times being shifted from said first beacon transmission times by a delay period, and wherein said wireless communication unit is to transmit at least one information element including timing information of said second beacon schedule.

27. The apparatus of claim 26, wherein said wireless communication unit is to transmit said information element prior to broadcasting one or more beacons according to said second beacon schedule.

28. The apparatus of claim 26, wherein said wireless communication unit is to reschedule the broadcasting of said beacons according to said second beacon schedule when said wireless communication unit is to back off transmission of one or more beacons at one or more beacon transmission times of the first sequence of beacon transmission times.

29. The apparatus of claim 26, wherein said wireless communication unit is to reschedule the broadcasting of said beacons according to said second beacon schedule when an actual transmission of a predefined number of beacons according to said first beacon schedule is delayed by at least a predefined period of time.

30. The apparatus of claim 26, wherein said wireless communication unit is to broadcast said plurality of beacons over a wireless communication medium, and wherein said wireless communication unit is to reschedule the broadcasting of said beacons according to said second beacon schedule when the wireless communication medium is occupied during at least a predefined time period beginning at a beacon transmission time of the first sequence of beacon transmission times.

31. The apparatus of claim 26, wherein said wireless communication unit is to reschedule the broadcasting of said beacons according to said second beacon schedule when the first sequence of beacon transmission times at least partially overlaps one or more beacons received by said wireless communication device.

32. The apparatus of claim 26, wherein said wireless communication unit is to broadcast said information element as part of at least one beacon.

33. The apparatus of claim 26, wherein said wireless communication unit is to transmit said information element as part of a dedicated management frame.

34. The apparatus of claim 26, wherein said wireless communication unit is to transmit said information element as part of a probe response.

35. The apparatus of claim 26, wherein said wireless communication unit is to transmit said information element over a backhaul channel connecting said wireless communication unit to one or more network controllers.

36. The apparatus of claim 26, wherein said information element includes a value of said delay period.

37. The apparatus of claim 26, wherein said information element includes a time at which said second beacon schedule is to begin.

38. The apparatus of claim 26, wherein said wireless communication unit is to determine said delay period based on a shift between said first sequence of beacon transmission times and a sequence of beacons received by said wireless communication unit.

39. The apparatus of claim 26, wherein said wireless communication unit is to randomly select said delay period.

40. The apparatus of claim 26, wherein said delay period is shorter than said beacon interval period.

41. A system comprising:
an access point (AP) including:
one or more antennas; and
a wireless communication unit to reschedule broadcasting of a plurality of beacons from a first beacon schedule to a second beacon schedule, the first beacon schedule including a first sequence of beacon transmission times separated by a predefined beacon interval period, and the second beacon schedule including a second sequence of beacon transmission times separated by said predefined beacon interval period, said second sequence of beacon transmission times being shifted from said first beacon transmission times by a delay period, and wherein said wireless communication unit is to transmit at least one information element including timing information of said second beacon schedule.

42. The system of claim 41, wherein said wireless communication unit is to transmit said information element prior to broadcasting one or more beacons according to said second beacon schedule.

43. An apparatus comprising:
a wireless communication unit to receive one or more beacons according to a first beacon schedule including a first sequence of beacon transmission times separated by a predefined beacon interval period, said wireless communication unit to receive at least one information element including timing information of a second beacon schedule including a second sequence of beacon transmission times separated by said predefined beacon interval period, said second sequence of beacon transmission times being shifted from said first beacon transmission times by a delay period, wherein said wireless communication unit is to receive one or more subsequent beacons according to said second beacon schedule.

44. The apparatus of claim 43, wherein said wireless communication unit is to receive said information element as part of at least one beacon.

45. The apparatus of claim 43, wherein said information element includes a value of said delay period.

46. A product including a non-transitory storage medium having stored thereon instructions that, when executed by a machine, result in:
broadcasting one or more first beacons according to a first schedule including a first sequence of beacon transmission times separated by a predefined beacon interval period;
determining a second schedule including a second sequence of beacon transmission times separated by said predefined beacon interval period, said second sequence of beacon transmission times being shifted from said first beacon transmission times by a delay period; and
transmitting at least one information element including timing information of said second sequence.

47. The product of claim 46, wherein the instructions result in transmitting said information element prior to broadcasting one or more beacons according to said second beacon schedule.

48. The product of claim 46, wherein the instructions result in rescheduling the broadcasting of said beacons according to said second beacon schedule when transmission of one or more beacons is to be backed off from one or more beacon transmission times of the first sequence of beacon transmission times.

49. The product of claim 46, wherein the instructions result in broadcasting said information element as part of at least one beacon.

50. The product of claim 46, wherein said information element includes a value of said delay period.
